(19) United States
(12) Patent Application Publication
(10) Pub. No.: US 2020/0298761 A1
(43) Pub. Date: Sep. 24, 2020

(54) DISPLAY SYSTEM FOR A VEHICLE

(71) Applicant: Visteon Global Technologies, Inc., Van Buren Township, MI (US)

(72) Inventors: Paul Fredrick Luther Weindorf, Novi, MI (US); Brian John Hayden, Royal Oak, MI (US)

(73) Assignee: Visteon Global Technologies, Inc., Van Buren Township, MI (US)

(21) Appl. No.: 16/825,495

(22) Filed: Mar. 20, 2020

Related U.S. Application Data
(60) Provisional application No. 62/821,204, filed on Mar. 20, 2019.
(60) Provisional application No. 62/824,559, filed on Mar. 27, 2019.

(51) Int. Cl. B60R 1/08; G02F 1/01; G02B 27/28; G02F 1/137; B60R 1/04; B60R 1/12

(52) U.S. Cl. CPC B60R 1/088; G02F 1/0136; G02B 27/281; B60R 2001/1223; B60R 1/04; B60R 1/12; G02F 1/137

(57) ABSTRACT

An electronic display system includes a display disposed in a housing. An electronic lens assembly is disposed in the housing proximate to and cooperating with the display. The electronic lens assembly includes one or more layers including a mirror element layer, a reflective polarizer layer cooperating with the mirror element layer, a rotator cell layer cooperating with the reflective polarizer layer, and a linear polarizer layer cooperating with the rotator cell layer and disposed opposite the reflective polarizer layer. A controller cooperates with the display and the electronic lens assembly and is configured to adjust the rotator cell layer of the electronic lens assembly between a reflective state in a first mode and a semi-transparent display state in a second mode.

### CROSS REFERENCE TO RELATED APPLICATIONS

This application claims the benefit of U.S. Provisional Patent Application No. 62/821,204, filed on Mar. 20, 2019, and entitled “E-MIRROR MATRIX SCATTER ABSORPTION,” and U.S. Provisional Patent Application No. 62/824,559, filed on Mar. 27, 2019, and entitled “MIRROR ASSEMBLY FOR A VEHICLE,” which are incorporated by reference in their entirety in this disclosure.

### BACKGROUND

Vehicles are equipped with electronic rear-view mirrors that allow drivers to see the environment behind the vehicles without turning their heads around. In the vehicular space, electronic-mirrors or e-mirrors have been developed to convey information in a vehicle. An electronic mirror is a display device that allows content to be viewable in the reflective state and to be a display device in the display state.

However, there is a need to have a traditional reflection-based mirror as a backup if the cameras or other image processing electronics become non-operational. Although not required, it is also desirable to have the features of automatic luminance control when in the display mode and auto dimming when in the traditional mirror mode.

Automatic dimming rear-view mirrors utilize a rear light sensor to measure an intensity of trailing headlights and a forward light sensor to measure an intensity of an ambient light to control the dimming. As the trailing headlight intensity changes, an electrochromic element within the automatic dimming rear-view mirrors changes an attenuation level of the trailing headlights reflected by the rear-view mirror. The attenuation adjustment of the rear-view mirror is based on an intensity of the ambient light. In low ambient conditions, the attenuation rapidly adjusts to changes in the trailing headlights. In higher ambient conditions, the attenuation slowly adjusts to the changes in the trailing headlights. The attenuation does not consider a human eye adaptation to changes in the ambient light and the trailing headlights.

FIG. 1 illustrates an electronic mirror or e-mirror 10 according to one prior art implementation. A rear cover 12 serves as a housing 14 for the mirror 10. The housing 14 cooperates with a front bezel 16 having an opening 18 sized to receive a lens 20. The lens 20 is adjusted between a reflective state and a display state by a toggle switch 22 to allow the electronic mirror to be oriented towards a headliner of a vehicle during a display mode.

FIG. 2 illustrates a side-view of the prior art electronic mirror 10 as described in FIG. 1. As shown, a display 24 cooperates with a mirror element 26, which is disposed proximate an electrochromic absorber 28. Conventionally, electrochromic materials have been used for the electrochromic absorber 28 of the electrochromic mirror element. Illumination 30 from a source element, such as headlights from a vehicle rearward of the mirror, may be projected through the electrochromic absorber 28 toward the mirror element 26.

The mirror element 26 may reflect about 50% of the light 32 and allow 50% transmission of content from the display 24 to be seen. A phenomenon known as matrix scatter may occur when light 32 enters the display 24. In an electronic mirror 10 that includes a display state and a mirror or reflective state, matrix scatter may be particularly noticeable when mirror reflectance is at its lowest level. Matrix scatter may form a star pattern and may include multiple colors due to, for example, a diffraction pattern. Collimated light 32, such as the light from headlights, may increase the visual effect of matrix scatter. Accordingly, rear view electronic mirrors that have a display state and a reflective state may experience a high level of matrix scatter in the reflective mode.

### SUMMARY

A display system includes a display disposed in a housing. An electronic lens assembly is disposed in the housing proximate to and cooperating with the display. The electronic lens assembly includes one or more layers including a mirror element layer, a reflective polarizer layer cooperating with the mirror element layer, a rotator cell layer cooperating with the reflective polarizer layer, and a linear polarizer layer cooperating with the rotator cell layer and disposed opposite the reflective polarizer layer. A controller cooperates with the display and the electronic lens assembly and is configured to adjust the rotator cell layer of the electronic lens assembly between a reflective state in a first mode and a semi-transparent display state in a second mode.

In another aspect, an electronic mirror assembly includes a housing and a bezel cooperating with the housing, the bezel defining at least one aperture therein. A display is disposed in the housing. The display includes a display element configured to present content and a backlight cooperating with the display element to source light to generate an image on the display element.

An electronic lens assembly is disposed in the housing proximate the display. The electronic lens assembly includes one or more layers, including a mirror element layer, a reflective polarizer layer cooperating with the mirror element layer, a rotator cell layer cooperating with the reflective polarizer layer, and a linear polarizer layer cooperating with the rotator cell layer and disposed opposite the reflective polarizer layer.

A light sensing system having at least one sensor that receives and detects light from a light source is provided. A controller is disposed in the housing and cooperates with the display, the electronic lens assembly and the light sensing system. The controller is configured to adjust the rotator cell layer of the electronic lens assembly between a reflective state in a first mode and a semi-transparent display state in a second mode in response to input from the light sensing system.

In yet another aspect, a light sensing system for adjusting a reflective state of an electronic lens assembly of an electronic mirror assembly includes at least one sensor. The at least one sensor includes an aspherical lens, a light sensor device, and a light pipe defining an optical center. The light pipe includes a first end proximate the aspherical lens and a second end proximate the light sensor device. The light sensor device is offset from the optical center of the light pipe and includes a photosensitive area that receives and detects the light from the light source.

A controller cooperates with the at least one sensor. The controller is configured to adjust the electronic lens assembly between a reflective state in a first mode and a semi-transparent display state in a second mode in response to input from the at least one light sensor.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a perspective view of a prior art electronic mirror.

FIG. 2 is an exploded side view of the prior art electronic mirror of FIG. 1.

FIG. 3 is an exploded perspective view of an electronic display system in accordance with one or more aspects of the disclosure.

FIG. 4 is a perspective view of a light sensing system for the electronic display system, which is in accordance with one or more aspects.

FIG. 5 is a top view of the light sensing system of FIG. 4, which is in accordance with one or more aspects.

FIG. 6 is a side, cutaway view of the light sensing system of FIG. 4, which is in accordance with one or more aspects.

FIG. 7 is a side, cutaway view of the light sensing system of FIG. 4, which is in accordance with one or more aspects.

FIG. 8 is a graph of optical gain of the light sensing system of FIG. 4, which is in accordance with one or more aspects.

FIG. 9 is a graph of optical gain of the light sensing system of FIG. 4, which is in accordance with one or more aspects.

FIG. 10 is a schematic diagram illustrating an exemplary implementation of the electronic display system including a display and electronic lens assembly in accordance with one or more aspects of the disclosure.

FIG. 11 is a fragmentary side plan view illustrating at least one exemplary implementation of the electronic display system including a display and electronic lens assembly in accordance with one or more aspects of the disclosure.

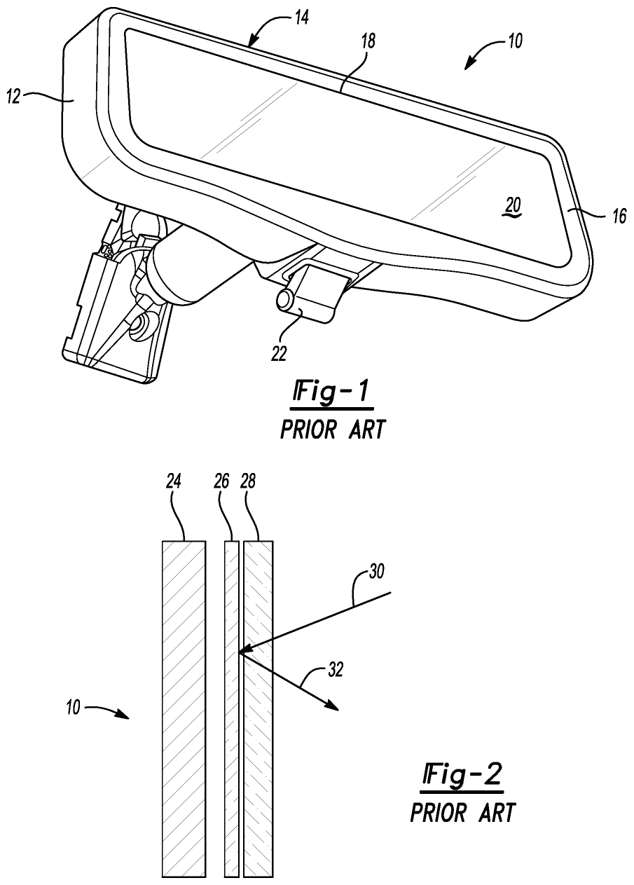

The present disclosure may have various modifications and alternative forms, and some representative aspects are shown by way of example in the drawings and will be described in detail herein. Novel aspects of this disclosure are not limited to the forms illustrated in the above-enumerated drawings. Rather, the disclosure is to cover modifications, equivalents, and combinations falling within the scope of the disclosure as encompassed by the appended claims.

### DETAILED DESCRIPTION

Those having ordinary skill in the art will recognize that terms such as “above,” “below,” “upward,” “downward,” “top,” “bottom,” “forward,” “rearward,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

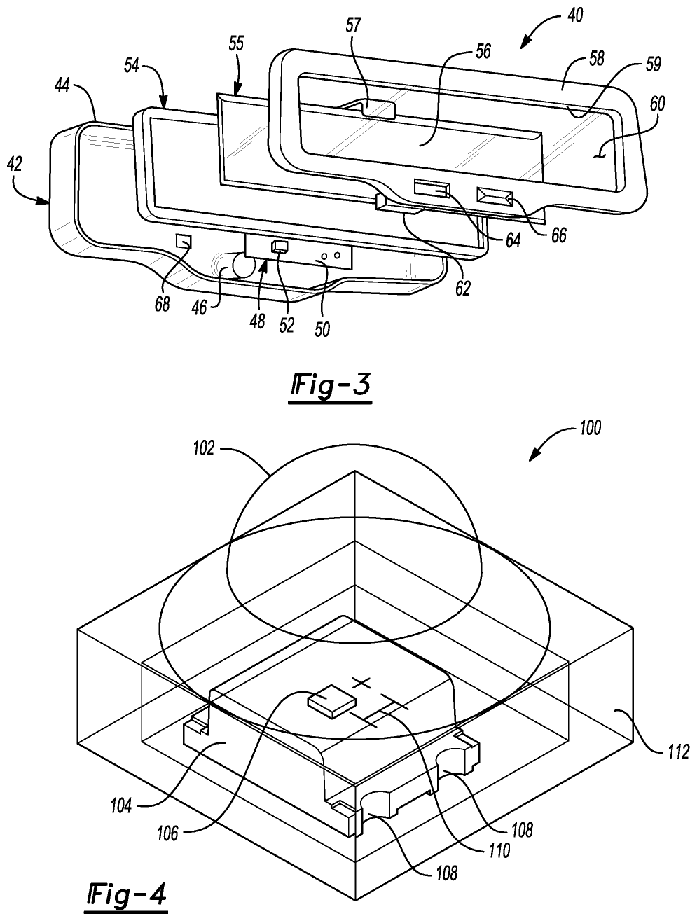

Referring to the Figures, wherein like numerals indicate like parts throughout the several views, FIG. 3 illustrates an electronic display system 40. The electronic display system 40 may be a display system in the form of a mirror assembly, such as an electronic mirror or e-mirror. The mirror assembly may include a rear-view mirror, a visor mirror, an exterior side mirror or another type of vehicle display and/or mirror. Alternatively, the display system 40 in accordance with one or more aspects of the disclosure may comprise another type of display system, such as an instrument cluster, heads-up display or the like.

The electronic display system 40 shown in FIG. 3 may be configures as an electronic mirror assembly 42 for use in the interior of a motor vehicle. The electronic mirror assembly 42 may be positioned adjacent a forward portion of a vehicle interior (not shown). For example, in one or more aspects, the electronic mirror assembly 42 may additionally be positioned on or proximate a windshield or windscreen (not shown) of the vehicle. It is understood that the electronic mirror assembly 42 or other form of electronic display system could be implemented in other regions of the vehicle, such as dashboard, console or other interior space and positioned on or proximate a structural portion of the vehicle, including, but not limited to, a vehicle panel or headliner, vehicle roof surface or vehicle frame to accomplish the objectives of this disclosure.

The electronic mirror assembly 42 includes housing 44 that may receive and support one or more components of the electronic mirror assembly 42. The housing 44 cooperates with positioning elements 46 to mount the electronic mirror assembly 42 to a portion of the vehicle interior (not shown). The electronic mirror assembly 42 of the electronic display system 40 may include a control circuit or controller 48 having a printed wire board or printed circuit board (PCB) 50 and one more input devices 52 mounted thereon in electrical communication with the PCB 50. The PCB 50 may include one or more sensors, a processor, and memory, as well as other components, such as a display driver, and a battery.

The controller 48 may include one or more processors, each of which may be embodied as a separate processor, an application specific integrated circuit (ASIC), or a dedicated electronic control unit. The controller 48 may be any sort of electronic processor (implemented in hardware, software, or a combination of both) installed in a vehicle to allow the various electrical subsystems to communicate with each other. The controller 48 also includes tangible, non-transitory memory (M), e.g., read only memory in the form of optical, magnetic, and/or flash memory.

The controller 48 may be equipped with memory for performing a set of program instructions. The memory may be a non-transitory computer-readable medium. At least one memory including computer-program instructions may be configured to, with at least one processor, cause the controller to carry out a process. Computer-readable and executable instructions embodying the present method may be stored in memory (M) and executed as set forth herein. The executable instructions may be a series of instructions employed to run applications on the controller 48 (either in the foreground or background), and allow either automated control of the vehicular subsystems, or direct control through engagement of an occupant of the vehicle in any of the provided human machine interface (HMI) techniques, such as the input device 52.

The input device 52 may include any type of device that provides input the controller 48, such as touch-activated instructions inputted from a touch screen, voice-activated commands input from an audio device, manual inputs, such as a mechanical or electrical stimulus, external inputs from an external device, or the like, that activates, deactivate, or adjusts one or more functions of the electronic mirror assembly 42. In one or more non-limiting aspects of the disclosures, the input device 52 may be a button on the PCB 50 that communicates with the controller 48 to adjust the electronic mirror assembly 42 between one or more display modes, such as from a reflective state in a first mode or a mirror mode and a display state in a second mode or a video mode, may activate or deactivate a display 54 or adjust an optical property of the electronic mirror assembly 42.

The electronic mirror assembly 42 includes a projection device or display 54 disposed within the housing 44. The display 54 may be any sort of device capable of generating or configured to generate an image or digitally render information to present to a viewer for display on a projection surface such as an electronic display. For example, in one or more aspects, the display 54 may include a backlight 70 and a projection surface or display element 72 cooperating with the backlight 70 as shown in FIG. 10.

The display 54 may implement a standard display with a variable luminance capability. The display 54 is generally operational to provide visual information to a user. In some aspects, the display 54 may be a thin-film-transistor display with an active backlight. In other aspects, the display 54 may be a liquid crystal display with the active backlight. Other display technologies may be implemented to meet the design criteria of a particular application. In a first mode or mirror mode, a brightness of the display 54 may be set to a minimum controlled value. In a display mode, the brightness of the visual information presented by the display 54 may be controlled based on the rear light intensity and the ambient light intensity.

An electronic lens assembly 55 may be configured as an electronically variable optical device adjustable between a first mode or mirror mode and a second mode or display mode. The electronic lens assembly 55 is generally operational to provide an active system to control the mirror reflection rate (or level). In the first mode or mirror mode, the electronic lens assembly 55 may be adjusted by the controller 48 to vary the reflection rate based on the rear light intensity and the ambient light intensity. In the second mode or display mode, the electronic lens assembly 55 may be adjusted by the controller 48 to provide a maximum transmission rate of the visual information on the display 54 that is viewable through the electronic lens assembly 55. The maximum controlled transmission rate may occur at a minimum controlled reflection rate.

The electronic lens assembly 55 may include one or more layers cooperating to provide the electronically variable optical device. The one or more layers of the electronic lens assembly may include a mirror element or mirror element layer 56 having a first side disposed proximate to and adjustable relative to a light emission direction of the display 54 and a second side opposite the first side. The mirror element layer 56 includes a semi-transparent reflective surface. The semi-transparent reflective surface of the mirror element layer 56 may be one of a semi-transparent mirror or a semi-transparent reflective polarizing layer.

For example, the mirror element layer 56 may include a partially reflective surface that provides a mirror surface to reflect images from the rear of the vehicle when the display 54 is inactive. The mirror element layer 56 may additionally incorporate a partially transparent surface that allows information or content generated on the display 54 to be viewed by a viewer through the mirror element layer 56. The mirror element layer 56 may also be an active polarizer.

A flex element 57 may implement an electrical interface. The flex element 57 is generally operational to operate or energize the one or more layers of the electronic lens assembly 55 in the electronic mirror assembly 42. In completed assemblies, the flex element 57 may electrically connect to the one or more layers of the electronic lens assembly 55.

The housing 44 of the electronic mirror assembly 42 may further include a cover surface or bezel 58 at least partially enclosing one or more of the controller 48, display 54 and electronic lens assembly 55 of the electronic mirror assembly 42. A bezel 58 cooperates with the housing and defines at least one aperture 59 or open side therein may be configured to face a viewer of the electronic mirror assembly 42 and is sized to at least partially receive and cooperate with a lens 60. The bezel 58 may also include one or more openings for other elements, switches and/or sensors. The lens 60 may be disposed proximate the electronic lens assembly 55 and is generally transparent to allow images generated by the display 54 or images reflected by the electronic lens assembly 55 to be viewed by the viewer. It is also understood that the lens 60 may be incorporated as part of the electronic lens assembly 55. The electronic lens assembly 55 may be in a generally parallel, coplanar arrangement with the lens 60.

A switch or button 62 cooperates with the input device 52 and extends through an aperture 64 in the bezel 58. The button 62 may be positioned to align with an opening 64 in the front bezel 58. The button 62 may have one or more functions and may be configured as one or more buttons 62.

In one or more of the aspects, the switch or button 62 additionally may cooperate with the input device 52 to adjust the one or more components of the electronic mirror assembly 42, such as adjustment of the electronic lens assembly 55 from a first position to at least one second position. A light sensing system 100 may also be provided in the bezel 58. The light sensing system may include a rear facing light sensor, shown as reference numeral 66 in the Figures, and may further include a front facing light sensor 68. The light sensing system 100 may record ambient lighting conditions and cooperate with the controller 48 to adjust the luminance settings of the display 54 or the mirror reflectance of the electronic lens assembly 55.

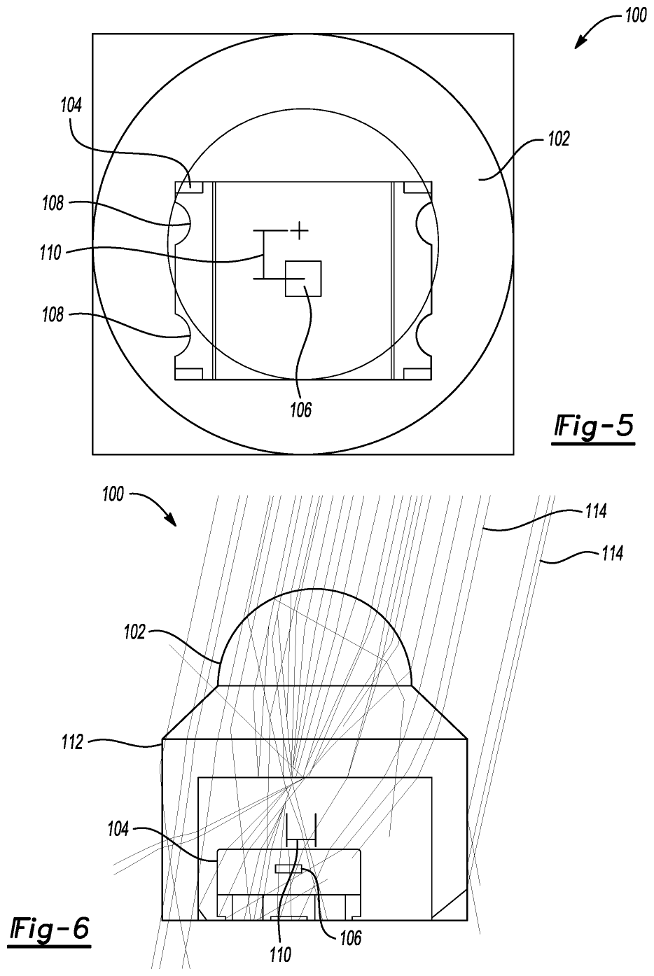

Referring now to FIGS. 4-9, the light sensing system 100 of the electronic display system is described in greater detail. The light sensing system 100 may include at least one sensor having an aspherical lens 102. The aspherical lens 102 may be disposed on the bezel 58 as shown in FIG. 3 and may include an anti-glare coating. The aspherical lens 102 may be adjacent to a light pipe 112. The light pipe may define an optical center include a first end that may be proximal to the aspherical lens 102, and a second end that may be distal to a light sensor device.

In one non-limiting aspect, the aspherical lens 102 may be formed with a 2.0 mm diameter, a 1.0 mm radius spherical dome, and a 2.0 mm overall length. In another non-limiting aspect, the aspherical lens 102 may be formed with a 3.0 mm diameter, a 1.0 mm radius spherical dome, and a 2.0 mm overall length. Alternative dimensional values are also envisioned for the aspherical lens 102.

The at least one sensor of the light sensing system 100 may further include at least one light sensor device 104. The light sensor device 104 may be disposed at the second end of the light pipe 112. The light sensor device 104 may be a logarithmic light sensor. The light sensor device 104 may include a dynamic range of operation, particularly for light levels. For example, the light sensor device 104 may be used in daytime operation or similar high illuminance conditions, the light sensor device 104 may be used in nighttime operation or similar low illuminance conditions, and the light sensor device 104 may be used throughout a range between daytime operation and nighttime operation.

For example, when the light sensor device 104 is the logarithmic sensor, the logarithmic sensor may perform automatic dimming during nighttime operation, and the logarithmic sensor may perform automatic luminance control during daytime operation. The light sensor 104 may be an SFH 5711, High Accuracy Ambient Light Sensor, from OSRAM Opto Semiconductors GmbH, with headquarters in Regensburg, Germany. In the light sensing system 100, the light sensor 104 may sense light at levels less than 1 LUX, such as 0.1 LUX, to levels far greater than 1 LUX, such as 60 LUX.

The light sensor device 104 may include a photosensitive area 106. The light sensor device 104 may be offset 110 from the optical center defined by the light pipe 112. The offset 110 of the light sensor device 104 may be set at a predetermined distance. For example, the offset 110 of the light sensor device 104, such as the photosensitive area 106, may be 0.4 mm. As another example, the offset 110 of the light sensor may be 0.65 mm. The offset 110 may be selected based on a design value for the angle of the mirror assembly 10 relative to the center-plane of the vehicle. The light sensor device 104 may include electrically conductive pins 108. The electrically conductive pins 108 may be disposed at the second end of the light pipe 112.

In one non-limiting aspect of the disclosure shown in FIG. 3, the light sensing system 100 may include a first sensor 66 cooperating with the bezel 58 of the electronic mirror assembly 42 and a second sensor 68 disposed on the housing 44 of the electronic mirror assembly 42 of the electronic display system 40. The housing 44 may include an aperture for receiving the second sensor 68. The second sensor 68 may generally be disposed on the electronic mirror assembly 42 opposite the first sensor 66, wherein the first light sensor 66 may have a field of view directed toward a rear of the vehicle. Conversely, the second light sensor 68 may have a field of view directed toward a front of the vehicle. As such, the first light sensor 66 may be referred to as a rear-facing light sensor, and the second light sensor 68 may be referred to as a front-facing light sensor.

In one non-limiting aspect, the second light sensor 68 or front-facing light sensor of the electronic mirror assembly 42 of the electronic display system 40 may be an ambient light sensor that may be configured to generate an ambient intensity value by logarithmic sensing the ambient light signal. The first light sensor 66 or rear-facing light sensor of the electronic mirror assembly 42 may be configured to generate a rear intensity value by logarithmic sensing the rear light signal proximate the electronic mirror assembly 42. A controller 48 of the electronic display system 40 may be configured to generate the reflectance value in response to the ambient intensity value and the rear intensity value measured by the first light sensor 66 and second light sensor 68. The refection value generally adjusts the reflectance rate of the rear light signal by the electronic display system 40 with a negative fractional power of the rear intensity value. The reflected light signal may be viewed by the user at an intensity level that is based on both a brightness of the rear light signal and a brightness of the ambient light signal.

Referring to FIG. 6, a side, cutaway view of the light sensing system 100 is illustrated, which is in accordance with one or more aspects. Light 114 is shown entering the aspherical lens 102, wherein at least some of the light 114 being focused by the aspherical lens 102 is directed toward the photosensitive area 106 of the light sensor device 104.

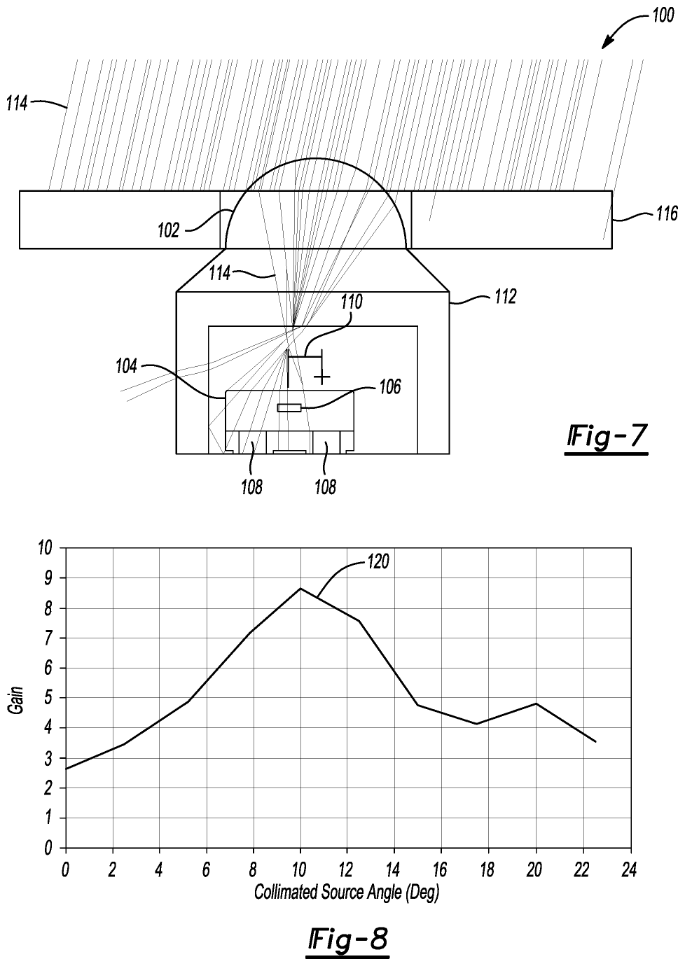

Referring to FIG. 7, a side, cutaway view of the light sensing system 100 is illustrated, which is in accordance with one or more aspects. The light sensing system 100 includes an aperture collar 116. The aperture collar 116 may receive the aspherical lens 102. The aperture collar 116 may surround the aspherical lens 102. The aperture collar 116 may conceal a portion of the aspherical lens 102. As one example, the aperture collar 116 may form part of the bezel 58. The aperture collar 116 may prevent a double-peak condition from occurring for optical gain.

The light sensing system 100 may include an amplifier that boosts an output from the light sensor 104. The amplifier may be a “rail-to-rail” output type amplifier. The amplifier may include one or more load resistors. The amplifier and/or the one or more load resistors may set a gain factor for the light sensor device 104. For example, the gain of the amplifier may be set at approximately 1.18. The gain factor may be set to not exceed the dynamic range of the light sensor 104.

According to one or more aspects, in a light sensing system 100, optical gains may be adjustable depending on dimensional size of an aspherical lens 102. For example, for the vehicle, the size of the aspherical lens 102 may be selected to compensate for vehicle rear window light transmission characteristics. Additionally, a focus point of the aspherical lens 102 may be optimized to achieve a desired diffusion profile. Further, an offset for the light sensor device 104 in relation to an optical center of a light pipe 112 may be optimized to achieve a desired optical gain profile. Additionally, the light sensing system 100 may be used in conjunction with or separate from a second light sensing system.

FIG. 8 illustrates a graph 120 of optical gain versus collimator source angle of light from the light source for the light sensing system 100, where the offset 110 is set at 0.65 mm and the overall length from the light pipe 112 to the aspherical lens 102 is 5.1 mm. As shown in the graph of FIG. 8, optical gain is at a maximum of around 8.5 at 10° (10 degrees) for the angle of light from the light source. Additionally, at 12° (12 degrees) for the angle of light from the light source, the optical gain is around 7.75. A defocusing condition exists, which reduces optical gain at, for example, the 12° (12 degree) angle of light from the light source. That defocusing condition generally flattens out the optical gain, which may allow the occupant greater flexibility in orienting the mirror assembly 42, particularly in relation to the center plane.

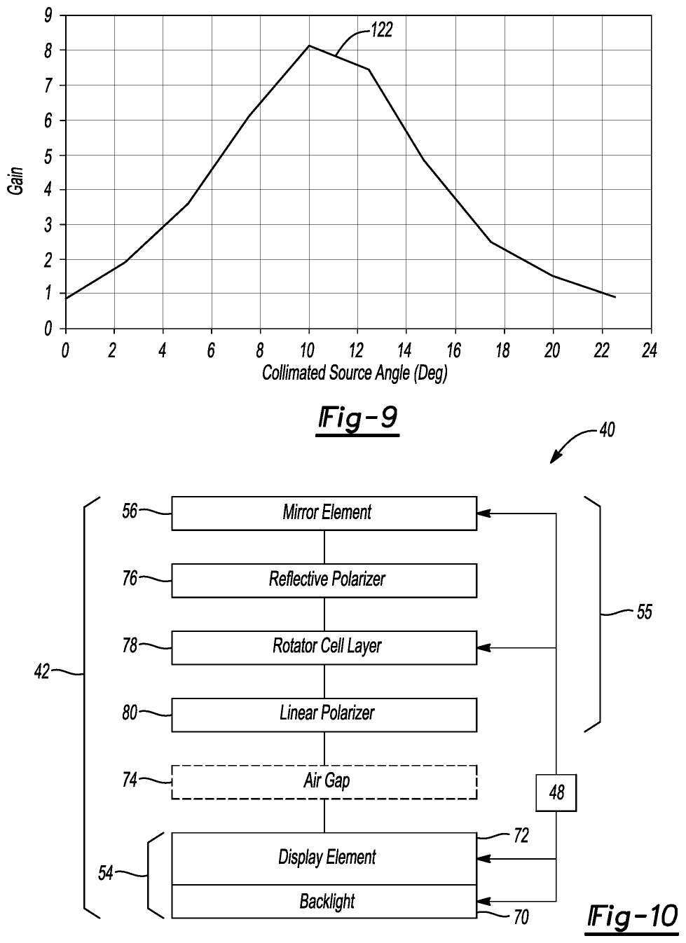

FIG. 9 illustrates a graph 122 of optical gain versus collimator source angle of light from the light source for the light sensing system 100, where the offset 110 is set at 0.65 mm, the overall length from the light pipe 112 to the aspherical lens 102 is 5.1 mm, and the aperture collar 116 is used. The aperture collar 116 yields a single-peak condition, as opposed to the double-peak condition witnessed in FIG. 8. For example, as seen in the graph 120 of FIG. 8, a first peak for optical gain occurs at 10° (10 degrees) and a second peak occurs at 20° (20 degrees). Including the aperture collar with the offset set at 0.65 mm and the overall length from the light pipe 112 to the aspherical lens 102 set at 5.1 mm may result in a single-peak condition for optical gain, instead of the double-peak condition witnessed in the graph 122 in FIG. 9.

In FIG. 9, the maximum optical gain, which may be around 8.1, may occur at 10° (10 degrees) for the angle of light from the light source. At 12° (12 degrees), the optical gain may be around 7.5. As such, the aperture collar 116 may achieve the single-peak condition, while having negligible impact on optical gain at certain angles of light. For example, when compared to FIG. 8, the maximum optical gains may occur at 10° (10 degrees) and may be nearly identical, as may the values for optical gains at 12° (12 degrees).

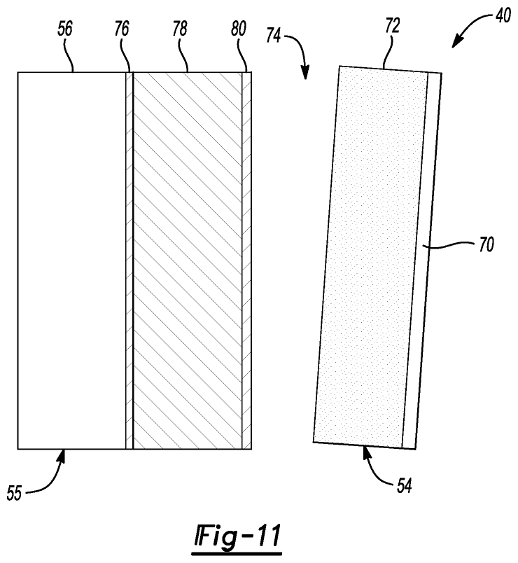

Referring now to FIGS. 10-11, a diagram of the electronic mirror assembly 42 of the electronic display system 40 is illustrated. The electronic mirror assembly 42 includes a display 54 having at least a backlight 70 and a projection surface or display element 72 cooperating with the backlight 70 and configured to present content on the display element 72. The backlight 70 sources light to the display element 72. The display 54 may be a light emitting display, such as an organic light emitting diode (OLED) display, liquid crystal display (LCD) a thin-film transistor (TFT) display or other suitable display for the presentation of information. The backlight 70 sources light to the projection surface or display element 72, which, using technology such as liquid crystal cell-based technology, determines a pattern to illuminate and make viewable to the viewer of the display 54.

As is best shown in FIG. 10, the one or more layers of the electronic lens assembly 55 may include a mirror element layer 56 and a reflective polarizer or reflective polarizer layer 76 disposed proximate to and cooperating with the second side 56b of the mirror element layer 56. The reflective polarizer layer 76 may be formed as a reflective polarizer film. Two or more classes of reflective polarizer materials may be used for the reflective polarizer layer 76, including, but not limited to, 3M′ Reflective Polarizer Mirror (RPM) and 3M™ Windshield Combiner Film (WCF), both available from THE 3M COMPANY, with headquarters located in Maplewood, MN. Other reflective polarizer materials having similar properties such as wire grid polarizers may be used to form the reflective polarizer layer 76 in other aspects.

A rotator cell layer 78 may be disposed adjacent and cooperate with the reflective polarizer layer 76. The rotator cell layer 78 may be formed as an electronically controlled active wave plate. The rotator cell layer 78 may include a liquid crystal layer such as a Thin Film Transistor (TFT) liquid crystal display (LCD), otherwise referred to as the TFT display layer. Alternatively, the rotator cell layer 78 may be formed as another form of liquid crystal cell device configuration, such as multiplexed film compensated super twist nematic (FSTN), twisted nematic (TN), in-plane switching (IPS), multi-domain vertical alignment (MVA) or another type of liquid crystal display mode that causes light polarization rotation.

The rotator cell layer 78 may be an active half-wave plate and may have two controllable states, which may be controlled by controller 48. The controller 48 may be configured to control the rotator cell layer 78 to be in a selected state according to a desired mode of operation of the electronic mirror assembly 42. One of these states may be no change to polarized light. In this state, polarized light may be pass through without rotation. The other state of the two states may be rotation of polarized light by 90° (90 degrees). One of these states may be used for the first mode or mirror mode and the other state may be used for the second mode or display mode.

The liquid crystal layer of the rotator cell layer 78 rotates polarized light by 90° (90 degrees). In one non-limiting aspect, the rotator cell layer 78 further comprises a liquid crystal layer, wherein the liquid crystal layer of the rotator cell layer 78 is activated to rotate polarized light by 90 degrees for the reflective state in the first mode and is deactivated for the semi-transparent display state in the second mode. In general, propagating light waves generate an electric field. The electric field oscillates in a direction that is perpendicular/orthogonal to the light wave's direction of propagation. Light is unpolarized when the fluctuation of the electric field direction is random. Light may be described as polarized when fluctuation of the electric field is highly structured, with laser beams being a common example of highly polarized light and sunlight or diffuse overhead incandescent lighting being examples of unpolarized light.

In one or more aspects of the disclosure, the display 54 and the rotator cell layer 78 may be electrically coupled to a controllable voltage source and the controller 48. In response to activation of the display 54 by the controller 48, the controllable voltage source may be configured to apply a voltage to adjust the rotator cell layer 78. In response to activation of the display 54 by the controller 48 based upon output received from at least one of the input device 52 or light sensor system 100, the controllable voltage source may be configured to apply a voltage to adjust the rotator cell layer 78 to adjust the electronic mirror assembly 55 between a reflective state in a first mode or mirror mode and a semi-transparent display state in a second mode or a display mode. The control voltage source may be applied by the controller 48 so that the crystals of the rotator cell layer 78 may either be orthogonal to the display 54 or perpendicular to the display 54. When the crystals are parallel to the display 54, the polarization of light is rotated. The controller 48 may either apply a drive voltage to turn on the rotator layer or remove the drive voltage to turn off the rotator cell layer 78. The controller 48 may further apply a pulse width modulated (PWM) voltage to the display 54 described herein.

A linear polarizer or linear polarizer layer 80 may be disposed adjacent and cooperate with the rotator cell layer 78. The linear polarizer layer 80 may be disposed on an opposing portion or side of the rotator cell layer 78 from the reflective polarizer layer 76.

In a non-limiting aspect of the disclosure, at least one air gap layer 74 may provided between the display 54 and the linear polarizer layer 80 of the electronic lens assembly 55. The at least one air gap layer 74, or index matching layer, may overlap the display 54 and/or the electronic lens assembly 55. FIG. 11 illustrates a variation for implementation of the at least one air gap layer 74 in the display system 40. Referring to FIG. 11, the at least one air gap layer 74 introduced in between the display element 72 of the display 54 and the linear polarizer layer 80 of the electronic lens assembly 55.

The electronic lens assembly 55 of the electronic mirror assembly 42 may eliminate or reduce the scattering of light by rotating the polarization of the light passing through the reflective polarizer layer 76 so that light is absorbed by the linear polarizer layer 80. One way to rotate the polarization is to use the active half-wave plate of the rotator cell layer 78 placed between the reflective polarizer layer 76 and the linear polarizer layer 80. The active half-wave plate of the rotator cell layer 78, which may use a twisted nematic (TN) liquid crystal cell, may have two operating positions.

In a first mode or mirror mode, the active half-wave plate of the rotator cell layer 78 is not driven or activated by the controller 48. Polarized ambient light from a headlight or the like is rotated by 90° (90 degrees) and may be absorbed by the linear polarizer layer 80, which eliminates light matrix scatter by eliminating light entering the display element 72 of the display 54. In a second mode position or display mode, the rotator cell layer 78 is driven or activated by the controller 48, such that no change is made to polarized light. The polarized light is not rotated by the rotator cell layer 78 such that the polarized light is aligned to the transmission axis and may pass through the reflective polarizer layer 76 and thereby, the light from the display 54 through the linear polarizer layer 80. The controller 48 may drive or activate the rotator cell layer 78 of the electronic lens assembly 55 in response to input from one or more output sources, including, but not limited to, a signal or output from the input device 52 and/or as signal or output from the light sensor system 100 as described herein.

A solution to eliminate matrix scatter from the display 54 from the electronic mirror assembly 42 of the electronic display system 40 is described in greater detail. Matrix scatter is described as a star pattern emanating from the specular distinct image, and often there will be different colors visible because of the diffraction pattern generating matrix scatter. Therefore, reflected matrix scatter causes the light component, which is passed through an electronic lens assembly 55, to not be effectively absorbed as a beam stop by a display 54, which is, in turn, reflected towards the viewer. Since the matrix scatter is caused by structures (e.g. row and column lines) internal to the display 54, external anti-reflection counter measures are not be effective for this reflection component.

In one or more aspects of the disclosure, an antireflection (AR) layer may be provided between the display 54 and the electronic lens assembly 55 to reduce the reflection rate by approximately 4%. Between the display 54 and the electronic lens assembly 55, the use of an AR layer reduces the amount of reflection by 2% for each air to glass interface because only half of the light may go through the electronic lens assembly 55 due to the reflective polarization film. In one or more aspects, when index matching the glass to air or front display polarizer to air with AR coating or motheye film, light is minimally reflected at these interfaces to a reflectance of less than 0.4% reflection.

FIG. 11 illustrates one aspect to compensate for matrix scatter, namely, to tilt or position the display 54 on an angle in a non-planar arrangement relative to the electronic lens assembly 55 to reduce matrix scatter. In one non-limiting example, the display 54 may be tilted or positioned at an angle of about 4° (4 degrees) relative to the electronic lens assembly 55. For example, the top portion of the display 54 may be tilted away or positioned an angle of about 4° (4 degrees) from the electronic lens assembly 55 while the bottom portion of the display may be tilted toward the electronic lens assembly 55. Alternatively, the top portion of the display 54 may be tilted toward or positioned an angle of about 4° (4 degrees) relative to the electronic lens assembly 55 while the bottom portion of the display 54 may be tilted away from the electronic lens assembly 55.

The detailed description and the drawings or figures are supportive and descriptive of the disclosure, but the scope of the disclosure is defined solely by the claims. While some of the best modes and other aspects for carrying out the claimed teachings have been described in detail, various alternative designs and aspects exist for practicing the disclosure defined in the appended claims.

1. An electronic display system comprising:
a housing;
a display disposed in the housing;
an electronic lens assembly disposed in the housing proximate the display, wherein the electronic lens assembly includes one or more layers including:
a mirror element layer,
a reflective polarizer layer cooperating with the mirror element layer,
a rotator cell layer cooperating with the reflective polarizer layer, and
a linear polarizer layer cooperating with the rotator cell layer and disposed opposite the reflective polarizer layer; and
a controller disposed in the housing and cooperating with the display and the electronic lens assembly, wherein the controller is configured to adjust the rotator cell layer of the electronic lens assembly between a reflective state in a first mode and a semi-transparent display state in a second mode.

2. The electronic display system of claim 1 wherein the rotator cell layer further comprises a liquid crystal layer, wherein the liquid crystal layer of the rotator cell layer is activated to rotate polarized light by 90 degrees for the reflective state in the first mode and is deactivated for the semi-transparent display state in the second mode.

3. The electronic display system of claim 1 wherein the display further comprises a backlight and a display element configured to present content, wherein the backlight cooperates with the display element and sources light to generate an image on the display element.

4. The electronic display system of claim 1 further comprising an air gap layer introduced between the display and the linear polarizer layer of the electronic lens assembly.

5. The electronic display system of claim 5 wherein the air gap layer is introduced between the display element of the display device and a linear polarizer layer of the electronic lens assembly.

6. The electronic display system of claim 1 further comprising a light sensing system having at least one sensor cooperating with the controller, wherein the at least one sensor receives and detects light from a light source.

7. The electronic display system of claim 6 wherein the at least one sensor of the light sensing system further comprises an aspherical lens, a light sensor device, and a light pipe defining an optical center, the light pipe having a first end proximate the aspherical lens and a second end proximate the light sensor device.

8. The electronic display system of claim 6 wherein the light sensor device is offset from the optical center of the light pipe and includes a photosensitive area that receives and detects the light from the light source.

9. The electronic display system of claim 6 wherein the at least one sensor is a logarithmic light sensor.

10. The electronic display system of claim 6 wherein the at least one sensor of the light sensing system includes a first light sensor cooperating with a bezel of the electronic display system and a second sensor disposed on the housing opposite the first sensor on the bezel.

11. An electronic mirror assembly comprising:
a housing;
a bezel cooperating with the housing, the bezel defining at least one aperture therein;
a display disposed in the housing, wherein the display includes a display element configured to present content and a backlight cooperating with the display element to source light to generate an image on the display element;
an electronic lens assembly disposed in the housing proximate the display, wherein the electronic lens assembly includes one or more layers including:
a mirror element layer,
a reflective polarizer layer cooperating with the mirror element layer,
a rotator cell layer cooperating with the reflective polarizer layer, and
a linear polarizer layer cooperating with the rotator cell layer and disposed opposite the reflective polarizer layer;
a light sensing system having at least one sensor that receives and detects light from a light source; and
a controller disposed in the housing and cooperating with the display, the electronic lens assembly and the light sensing system, wherein the controller is configured to adjust the rotator cell layer of the electronic lens assembly between a reflective state in a first mode and a semi-transparent display state in a second mode in response to input from the light sensing system.

12. The electronic mirror assembly of claim 11 wherein the rotator cell layer further comprises a liquid crystal layer, wherein the liquid crystal layer of the rotator cell layer is activated to rotate polarized light by 90 degrees for the reflective state in the first mode and is deactivated for the semi-transparent display state in the second mode.

13. The electronic mirror assembly of claim 11 wherein the at least one sensor of the light sensing system further comprises an aspherical lens, a light sensor device, and a light pipe defining an optical center, the light pipe having a first end proximate the aspherical lens and a second end proximate the light sensor device.

14. The electronic mirror assembly of claim 13 wherein the light sensor device is offset from the optical center of the light pipe and includes a photosensitive area that receives and detects the light from the light source.

15. The electronic mirror assembly of claim 13 wherein the at least one sensor is a logarithmic light sensor.

16. The electronic mirror assembly of claim 13 wherein the at least one sensor of the light sensing system includes a first light sensor cooperating with the bezel and a second sensor disposed on the housing opposite the first sensor on the bezel.

17. A light sensing system for adjusting a reflective state of an electronic lens assembly of an electronic mirror assembly comprising:
at least one sensor including:
an aspherical lens,
a light sensor device, and
a light pipe defining an optical center, wherein the light pipe includes a first end proximate the aspherical lens and a second end proximate the light sensor device,
wherein the light sensor device is offset from the optical center of the light pipe and includes a photosensitive area that receives and detects the light from the light source; and
a controller cooperating with the at least one sensor, wherein the controller is configured to adjust the electronic lens assembly between a reflective state in a first mode and a semi-transparent display state in a second mode in response to input from the at least one light sensor.

18. The light sensing system of claim 17 wherein the at least one sensor is a logarithmic light sensor.

19. The light sensing system of claim 17 wherein the at least one sensor includes a first light sensor cooperating with a bezel of an electronic mirror assembly and a second sensor disposed on a housing of the electronic mirror assembly opposite the first sensor on the bezel.
